(19) United States
(12) Patent Application Publication
(10) Pub. No.: US 2021/0364280 A1
(43) Pub. Date: Nov. 25, 2021

(54) ROAD SURFACE AREA DETECTION DEVICE, ROAD SURFACE AREA DETECTION SYSTEM, VEHICLE, AND ROAD SURFACE AREA DETECTION METHOD

(71) Applicant: Mitsubishi Electric Corporation, Tokyo (JP)

(72) Inventors: Yohei MIKI, Tokyo (JP); Akihiro OBA, Tokyo (JP)

(73) Assignee: Mitsubishi Electric Corporation, Tokyo (JP)

(21) Appl. No.: 17/158,228

(22) Filed: Jan. 26, 2021

(30) Foreign Application Priority Data
May 25, 2020 (JP) 2020-090244

(51) Int. Cl. G01B 11/28; G06K 9/00; G01S 17/931; G01S 17/04; G01S 17/42; B60R 16/023

(52) U.S. Cl. CPC G01B 11/285; G06K 9/00805; G06K 9/00798; B60R 16/0231; G01S 17/04; G01S 17/42; G01S 17/931

(57) ABSTRACT

A road surface area detection device, which is capable of accurately determining a road surface shape, includes: a data accumulator accumulating a ranging point sequence measured in a circumferential direction for each depression angle by a sensor; an adjacent point specifying processing circuitry extracting an attention point in one of the ranging point sequences, and adjacent points located on a large depression angle side and a small depression angle side with respect to the depression angle for the one ranging point sequence; an angle calculator calculating an angle formed by the adjacent points with respect to the attention point, as a difference angle; and a shape calculator classifying the attention point based on a shape determination result using the attention point and the adjacent points, and calculates a road surface shape based on the classification.

### BACKGROUND OF THE INVENTION

### 1. Field of the Invention

The present disclosure relates to a road surface area detection device, a road surface area detection system, a vehicle, and a road surface area detection method.

### 2. Description of the Background Art

In recent years, various functions for assisting drivers have been developed and are being mounted on vehicles. As one of such functions, an automated traveling system for enabling automated traveling of a vehicle is being actively developed. In order to realize such an automated traveling system, it is essential to have high-accuracy sensing technology such as swift detection for surrounding objects and accurate information about a road surface state by various sensors mounted on a vehicle.

In order to realize smooth automated driving, in particular, detection for the road gradient of a road on which a vehicle is traveling is significantly important. As an example of conventional detection technology for road gradient, Patent Document 1 discloses technology that beams are emitted in three classes of long distance, middle distance, and short distance toward a road surface in front of a vehicle, the distance to the road surface for each class is calculated on the basis of a time period until the beam returns by being reflected from the road surface in front of the vehicle, and the road surface shape is recognized from the relationship among the calculated distances for the respective classes.

In addition, as in the case of laser imaging detection and ranging (LiDAR) which measures scattered light upon laser radiation emitted in a pulse form and analyzes the distance to a target object present at a long distance and the characteristics of the target object, a laser sensor for measuring the distance from a sensor body to an object in any direction is also used as means for measuring the road surface shape.

Patent Document 1: Japanese Laid-Open Patent Publication No. 2013-122753

In measurement for a road surface in front of a vehicle using a sensor as disclosed in Patent Document 1, if the measurement range is not only at a road surface in downward front of the sensor but also over a wide range including front, rear, left, and right of the sensor, it is possible to calculate a local shape of the road surface with the technology disclosed in Patent Document 1. However, it is not confirmed that a road surface is certainly present in the measurement direction, and therefore, even if it is determined that there are no recesses/projections as a result of calculation of the road surface shape, there can be a case where a part of a construction having no recesses/projections is present. Thus, there is a problem that a result of calculation of the road surface shape cannot be directly determined to indicate a road surface.

The present disclosure has been made to solve the above problem and an object of the present disclosure is to provide technology capable of more accurately determining the road surface shape.

### SUMMARY OF THE INVENTION

A road surface area detection device according to the present disclosure includes: a data acquisition unit which, with a sensor measuring ranging values representing distances to a target object by emitting a plurality of radiation signals different from each other in depression angles with respect to a perpendicular direction and measuring reflection signals obtained by the plurality of radiation signals being reflected from the target object, accumulates a ranging point sequence measured for each depression angle, the ranging point sequence being formed from the ranging values measured for a plurality of points along a circumferential direction around the perpendicular direction for each depression angle by the sensor; an adjacent point specifying unit which sets an attended ranging point in one of the ranging point sequences as an attention point, and from a pair of ranging point sequences respectively located on a large depression angle side and a small depression angle side with respect to the depression angle for the one ranging point sequence, extracts the ranging points having circumferential-direction angles closest to a circumferential-direction angle of the attention point, as a pair of adjacent points; an angle calculation unit which calculates an angle formed by the pair of adjacent points with respect to the attention point, as a difference angle; and a shape calculation unit which, on the basis of a shape determination result determined from a shape represented by the attention point and the pair of adjacent points using the difference angle, classifies the attention point into any of a road surface point constituting a road surface, a candidate point for the road surface point, and a ranging point not constituting a road surface among the ranging points, and calculates a road surface shape on the basis of the classification.

In the road surface area detection device according to the present disclosure, the shape calculation unit can classify the ranging points into three categories, i.e., a road surface point, a candidate point, and a ranging point that is not a road surface point, on the basis of a shape determination result for the attention point, thus providing an effect of enabling more accurate determination on the road surface shape.

### BRIEF DESCRIPTION OF THE DRAWINGS

FIG. 1 is a block diagram showing the configuration of a road surface area detection device according to the first embodiment of the present disclosure;

FIG. 2 is a flowchart in the road surface area detection device according to the first embodiment;

FIG. 3 shows information to be acquired by a laser sensor;

FIG. 4 is a view showing a laser sensor used in the road surface area detection device according to the first embodiment;

FIG. 5 is a plot example of ranging points with two axes indicating a circumferential-direction angle ω and a depression angle θ in measurement by the laser sensor used in the road surface area detection device according to the first embodiment;

FIG. 6 shows adjacent points with respect to an attended ranging point;

FIG. 7 shows adjacent points with respect to an attended ranging point, in ranging point sequences different among lasers;

FIG. 8 shows an angle α formed by adjacent points B and C with respect to an attention point A;

FIG. 9 shows division of areas using the ranging directions of ranging points of the laser sensor;

FIG. 10 shows definition of an area constituting road surface information in the height direction;

FIG. 11 shows definition of an area constituting road surface information in the circumferential direction;

FIG. 12 is a flowchart of extraction of ranging points constituting a road surface;

FIG. 13 shows road surface determination areas to be referenced in determination for whether or not a ranging point constitutes a road surface;

FIG. 14 shows an example of the order of road surface determination areas to be referenced when there is no representative ranging value;

FIG. 15 shows an example of a sensor which performs Raster-type scan;

FIG. 16 shows an example of ranging points acquired by Raster-type scan;

FIG. 17 is a block diagram showing the configuration of a road surface area detection device according to the second embodiment of the present disclosure;

FIG. 18 is a flowchart in the road surface area detection device according to the second embodiment;

FIG. 19 shows ranging point sequences in which adjacent points are searched for, in the case of Raster type;

FIG. 20 shows an example in which the shape cannot be calculated correctly, due to ranging accuracy;

FIG. 21 shows ranging point sequences in which adjacent points are searched for;

FIG. 22 is a block diagram showing the configuration of a road surface area detection device according to the third embodiment of the present disclosure;

FIG. 23 is a flowchart in the road surface area detection device according to the third embodiment;

FIG. 24 shows definition of an object presence determination area in the road surface area detection device according to the third embodiment;

FIG. 25 shows an area that might be a road surface;

FIG. 26 is a block diagram showing the configuration of a road surface area detection device according to the fourth embodiment of the present disclosure;

FIG. 27 is a flowchart in the road surface area detection device according to the fourth embodiment;

FIG. 28 shows an example of extraction of white lines in the road surface area detection device according to the fourth embodiment; and

FIG. 29 illustrates white lines at both ends of the own lane in the road surface area detection device according to the fourth embodiment.

### DETAILED DESCRIPTION OF THE PREFERRED EMBODIMENTS OF THE INVENTION

### First Embodiment

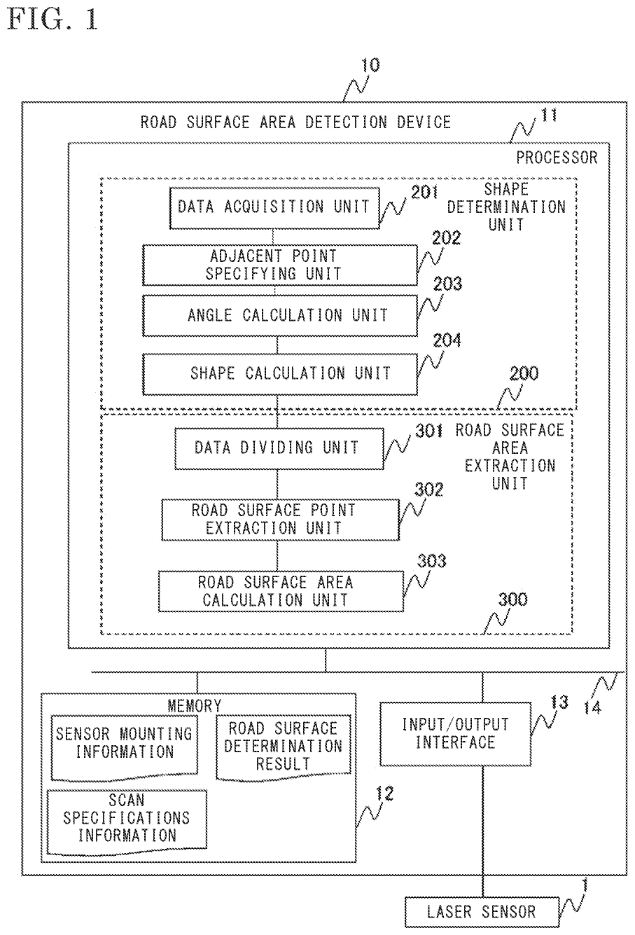

FIG. 1 shows a block diagram of a road surface area detection device according to the first embodiment of the present disclosure.

A road surface area detection device 10 is formed from, for example, a computer. In the present embodiment, the road surface area detection device 10 is an on-vehicle computer, i.e., a computer mounted in a vehicle body of a vehicle, but may be a server computer such as a cloud server, which is remotely located. The vehicle on which the road surface area detection device 10 is mounted has a laser sensor 1 such as LiDAR mounted on a predetermined mounting surface of the vehicle body. The road surface area detection device 10 is connected to the laser sensor 1 by a wire or wirelessly. The road surface area detection device 10 includes a processor 11 and also includes other hardware such as a memory 12 and an input/output interface 13. The processor 11 is connected to the other hardware via a signal line 14 and controls the other hardware.

The road surface area detection device 10 includes a shape determination unit 200 and a road surface area extraction unit 300, as function elements. The shape determination unit 200 includes a data acquisition unit 201, an adjacent point specifying unit 202, an angle calculation unit 203, and a shape calculation unit 204. The road surface area extraction unit 300 includes a data dividing unit 301, a road surface point extraction unit 302, and a road surface area calculation unit 303.

The functions of the shape determination unit 200 and the road surface area extraction unit 300 are implemented by software. However, some of these functions may be implemented by hardware. Specifically, the functions of the shape determination unit 200 and the road surface area extraction unit 300 are implemented by a road surface area detection program read by the processor 11. The road surface area detection program is a program that causes a computer to execute a shape determination process and a road surface area extraction process as the shape determination unit 200 and the road surface area extraction unit 300, respectively. The road surface area detection program may be provided in a form recorded in a computer-readable medium, may be provided in a form stored in a recording medium, or may be provided as a program product.

The processor 11 is a device for executing the road surface area detection program. The processor 11 is, for example, a central processing unit (CPU). The memory 12 is a device in which the road surface area detection program is stored in advance or temporarily. The memory 12 is, for example, a random access memory (RAM), a flash memory, or a combination of these.

The input/output interface 13 includes a receiver (not shown) for receiving data which is inputted to the road surface area detection program, and a transmitter (not shown) for transmitting data which is outputted from the road surface area detection program. The input/output interface 13 is a circuit which acquires data from the laser sensor 1 in accordance with a command from the processor 11. The input/output interface 13 is, for example, a communication chip or a network interface card (NIC).

The road surface area detection device 10 may further include an input device and a display as hardware. The input device is a device to be operated by a user for inputting data to the road surface area detection program. The input device is, for example, a mouse, a keyboard, a touch panel, or a combination of some or all of them. The display is a device for displaying data outputted from the road surface area detection program on a screen. The display is, for example, a liquid crystal display (LCD).

The road surface area detection program is read from the memory 12 by the processor 11 and executed by the processor 11. In the memory 12, not only the road surface area detection program but also an operating system (OS) is stored. The processor 11 executes the road surface area detection program while executing the OS. It is noted that a part or an entirety of the road surface area detection program may be incorporated in the OS.

The road surface area detection program and the OS may be stored in an auxiliary storage device (not shown). The auxiliary storage device is, for example, a hard disk drive (HDD), a flash memory, or a combination of these. In the case where the road surface area detection program and the OS are stored in the auxiliary storage device, the road surface area detection program and the OS are once uploaded onto the memory 12, further, read from the memory 12 by the processor 11, and then executed by the processor 11.

The road surface area detection device 10 may be formed by a plurality of processors as a substitute for the processor 11. The plurality of processors execute the road surface area detection program in a shared manner. This is because using a plurality of processors enables faster processing than in the case of a single processor. Each processor is formed by a CPU, for example.

Data, information, signal values, and variable values to be used, processed, or outputted by the road surface area detection program are stored in the memory 12, the auxiliary storage device, a register in the processor 11, or a cache memory. In particular, data that can be acquired by the input/output interface 13, a result of calculation by the road surface area detection program, mounting position information of the laser sensor 1, and scan specifications of the laser sensor 1, i.e., information such as scan pattern and scan interval thereof, are stored in the memory 12. The data and the information stored in the memory 12 are inputted/outputted in accordance with a request from the processor 11.

Before describing the details of operation of the road surface area detection device according to the present disclosure, first, the operation principle will be described below.

In the road surface area detection device according to the present disclosure, for each ranging point, i.e., attention point, acquired by the laser sensor 1, ranging points that are upwardly and downwardly adjacent to the attention point in terms of the depression angle and are close thereto in terms of the circumferential-direction angle, i.e., ranging points of which the ranging directions are close thereto, are extracted one by one as a pair of adjacent points. Then, the angle formed by the adjacent points and the attention point is calculated, and whether or not the attention point is present on a line connecting the adjacent points is determined. Further, the points that are determined to be present on such lines are classified into ranging points that are highly likely to constitute a road surface and ranging points that are candidates for constituting a road surface, using the determination result for the ranging points downward of the attended point, as a judgement material. In the next stage, regarding the extracted ranging points, from the above determination result therearound, ranging points that constitute a road surface, i.e., road surface points are selected, and data indicating a road surface area is outputted.

The operation principle of the road surface area detection device according to the present disclosure is as described above.

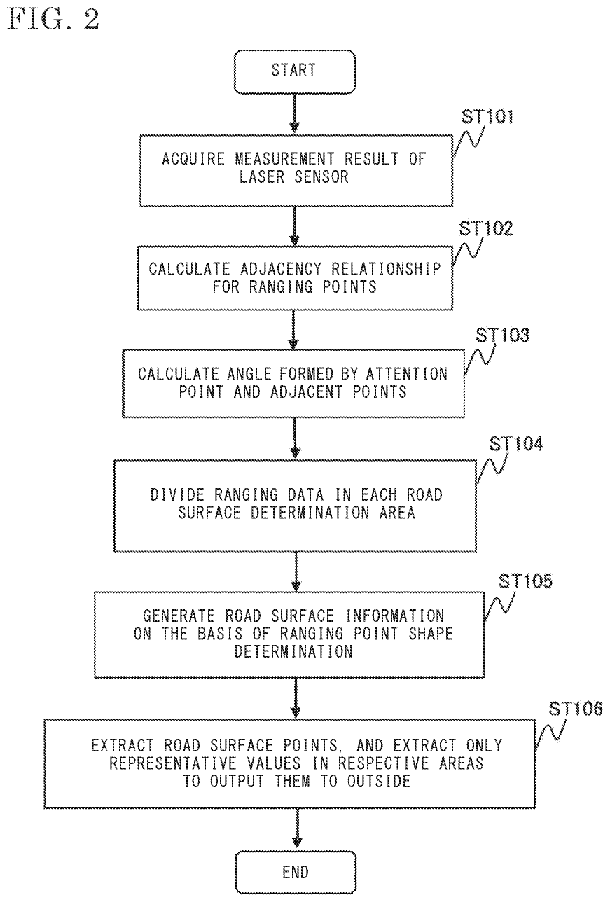

The road surface area detection device according to the first embodiment is realized by combining operations of the road surface area detection device 10 and the laser sensor 1. The operation of the road surface area detection device according to the first embodiment will be described with reference to the flowchart shown in FIG. 2.

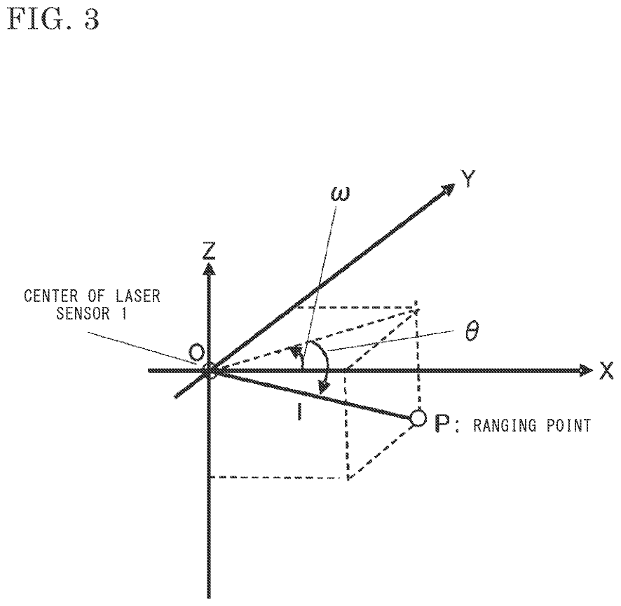

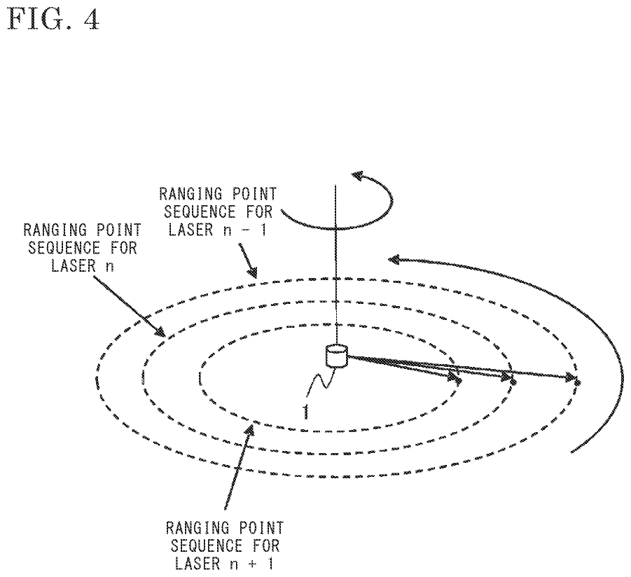

The laser sensor 1 used as a signal source by the road surface area detection device 10 according to the first embodiment is a sensor of a type that radiates laser beams (radiation signals) in a plurality of directions, receives reflection beams (reflection signals) reflected and returned from a target object, and thereby calculates the distance to the target object. As shown in FIG. 3, the laser sensor 1 of the above type measures a distance L(ω, θ)=1 to a target object in a direction represented by a depression angle θ of the laser sensor 1 with respect to a direction (hereinafter, referred to as perpendicular direction) perpendicular to the vehicle and an angle ω in a circumferential direction around the perpendicular direction (hereinafter, referred to as circumferential direction), with the laser sensor 1 as an origin. Here, the direction perpendicular to the vehicle is defined as a perpendicular direction with respect to a flat plane when the vehicle is placed on the flat plane. The laser sensor 1 used as a signal source by the road surface area detection device according to the first embodiment is of a type that, for example, as shown in FIG. 4, has a plurality of lasers different in depression angle and measures the distance to a target object while changing the ranging direction along the circumferential direction of the laser sensor 1.

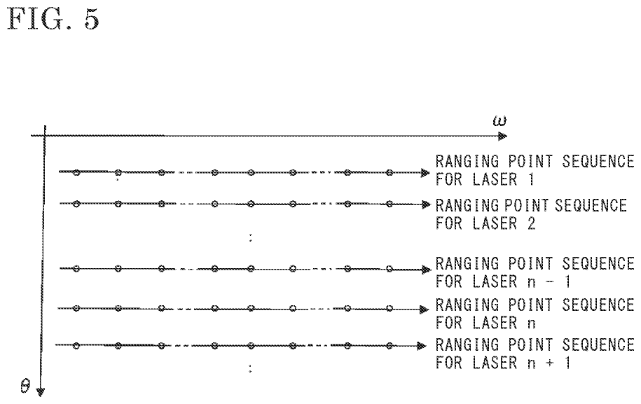

When data of the distances to the ranging points has been acquired by the laser sensor 1 as described above, in order to specify each ranging point, first, ID numbers are sequentially allocated as 1, 2, . . . , N from the laser having a small depression angle of radiation with reference to the center of the laser sensor 1 (hereinafter, the direction in which the depression angle decreases is referred to as upward direction, and the direction in which the depression angle increases is referred to as downward direction). Regarding the laser n (n=1, 2, . . . , N), the ranging point acquired as the mₙth (mₙ=1, 2, . . . , Mₙ) point from a scan start point in 1 frame in the circumferential direction is denoted by P(n, mₙ), the circumferential-direction angle is denoted by Ω(n, mₙ), the depression angle is denoted by Θ(n, mₙ), and the measurement distance is denoted by L(n, mₙ). With the circumferential-direction angle ω and the depression angle θ set on two axes, the acquired ranging points are plotted on a graph as shown in FIG. 5.

First, distance information from the laser sensor 1 to a target object acquired by the laser sensor 1 is stored into the data acquisition unit 201 via the input/output interface 13, and thus data for 1 frame is accumulated (FIG. 2, step ST101).

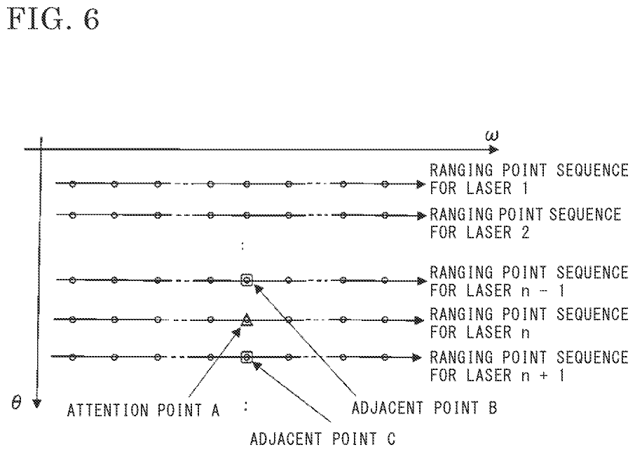

Next, in the adjacent point specifying unit 202, the closest ranging points in other ranging point sequences on the upward side and the downward side with respect to each ranging point are respectively extracted as adjacent points (FIG. 2, step ST102). Specifically, as shown in FIG. 6, two ranging points on the upward side and the downward side with respect to a ranging point A=P(n, mₙ) as an attention point are respectively set as an adjacent point B=P(n+1, b) and an adjacent point C=P(n−1, c).

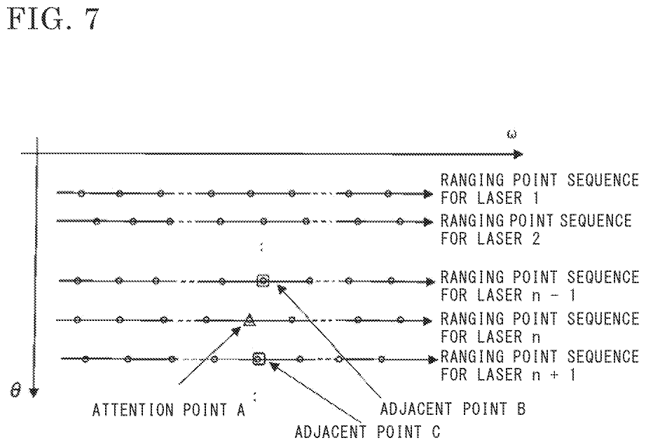

Regarding the adjacent points B and C, in the case where the circumferential-direction angles Ω of the respective lasers coincide with each other as shown in FIG. 6, b=mₙ and c=mₙ can be set. However, in the case where the circumferential-direction angles Ω of the respective lasers are not constant as shown in FIG. 7, or in the case where a ranging target object is an object that hardly reflects a signal and thus some ranging points are missing, b and c are calculated so as to satisfy the following Expression (1) and Expression (2). However, in the case where the values of b and c are great, i.e., the difference between the circumferential-direction angles Ω is great, it may be determined that there is no adjacent point, i.e., the ranging value is 0, to proceed to the subsequent processing.

$$\begin{matrix}[ Mathematical 1 ] & \\ b = {argmin}_{1 \leq b \leq {M}_{n + 1}} \vert Ω ( n , m ) - Ω ( n + 1 , b ) \vert & ( 1 ) \\ [ Mathematical 2 ] & \\ c = {argmin}_{1 \leq c \leq {M}_{n - 1}} \vert Ω ( n , m ) - Ω ( n + 1 , c ) \vert & ( 2 )\end{matrix}$$

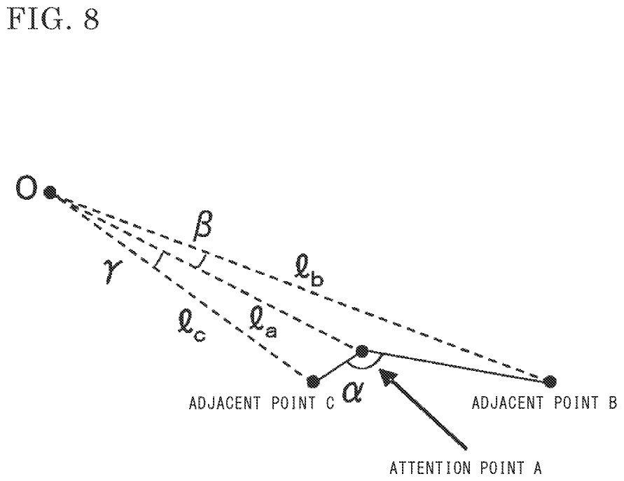

Next, in the angle calculation unit 203, an angle α formed by the adjacent points B and C with respect to the attention point A as shown in FIG. 8 is calculated on the basis of the attention point A and adjacent points B and C (FIG. 2, step ST103). For example, where the ranging value of the attention point A is defined as lₐ, the ranging value of the adjacent point B is defined as l_{b}, the ranging value of the adjacent point C is defined as l_{c}, the difference between the measurement directions of the attention point A and the adjacent point B is defined as difference angle _β, and the difference between the measurement directions of the attention point A and the adjacent point C is defined as difference angle γ, the angle α at the attention point A is calculated by the following Expressions (3) to (6). It is noted that calculation of the angle α is not limited to the following calculation expressions.

$$\begin{matrix}[ Mathematical 3 ] & \\ cos α = \frac{{u}^{2} + {v}^{2} - {t}^{2}}{2 uv} & ( 3 ) \\ [ Mathematical 4 ] & \\ {v}^{2} - {l}_{b}^{2} + {l}_{a}^{2} - 2 {l}_{b} {l}_{a} cos β & ( 4 ) \\ [ Mathematical 5 ] & \\ {u}^{2} = {l}_{c}^{2} + {l}_{a}^{2} - 2 {l}_{c} {l}_{a} cos γ & ( 5 ) \\ [ Mathematical 6 ] & \\ {t}^{2} = {l}_{b}^{2} + {l}_{c}^{2} - 2 {l}_{b} {l}_{a} cos ( β + γ ) & ( 6 )\end{matrix}$$

Next, in the shape calculation unit 204, on the basis of the calculated angle α, determination for classification into the following three categories is performed using Expression (7), to obtain a shape determination result S(n, mₙ) for the attention point A.

For the laser of which the value Θ of the depression angle is greatest, i.e., the laser directed most downwardly, an adjacent point in a further downward direction therefrom cannot be acquired, and therefore S(n, mₙ) is set to 1. The threshold is set in advance in accordance with ranging accuracy of the laser sensor 1 and an assumed environment, e.g., a paved road or a gravel road.

$$\begin{matrix}[ Mathematical 7 ] & \\ S ( n , {m}_{n} ) = \{ \begin{matrix}1 , & \vert 180 ° - α \vert < threshold and S ( n + 1 , c ) = 1 \\ 2 , & \vert 180 ° - α \vert > threshold \\ 3 , & \vert 180 ° - α \vert < threshold and S ( n + 1 , c ) \neq 1\end{matrix} & ( 7 )\end{matrix}$$

In the determination result by Expression (7), when the ranging point is determined as category 2, lines connecting from the attention point A to the adjacent points B and C are not on one straight line as a whole and thus have a recess/projection. Therefore, the attention point A is not treated as a ranging point that constitutes a road surface. On the other hand, in the cases of categories 1 and 3, the attention point A is present on one straight line together with the adjacent points B and C. Of these, the attention point A determined as category 1 is determined as indicating a straight line consecutively in the downward direction from the attended position, in the circumferential direction. Therefore, the attention point A is classified into a ranging point that is highly likely to constitute a road surface, i.e., a ranging point constituting a road surface, in other words, a road surface point. The ranging point determined as category 3 is the attention point A for which it is determined that there is a recess/projection at least once in the downward direction from the attended position. Therefore, while there is a possibility that the attention point A constitutes a road surface, there is also a possibility that the attention point A is a part of a flat surface other than a road surface. Therefore, the attention point A is classified into a candidate point for a ranging point constituting a road surface, i.e., a candidate point for a road surface point.

As described above, in the road surface area detection device according to the first embodiment, the shape calculation unit 204 can classify the ranging points into three categories, i.e., a road surface point, a candidate point, and a ranging point other than a road surface point, on the basis of the shape determination result S(n, mₙ) for the attention point A. Thus, an effect that the road surface shape can be more accurately determined is provided.

In the road surface area extraction unit 300, first, the data dividing unit 301 divides a set of ranging points into groups on a certain area basis, i.e., into road surface determination areas (FIG. 2, step ST104).

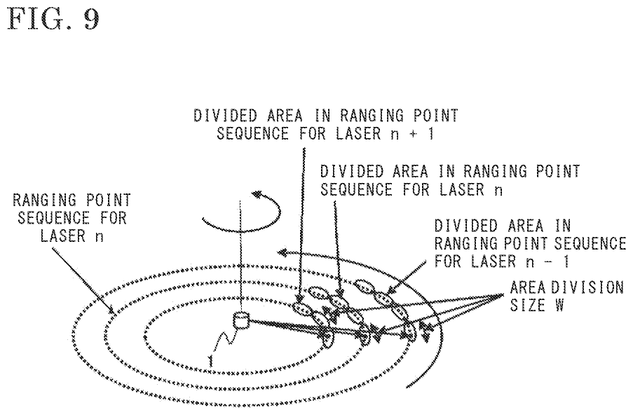

In the case of using the laser sensor 1 described in FIG. 4 as a sensor, the ranging points are divided into ranging point group sequences for each laser along the circumferential direction as shown in FIG. 9.

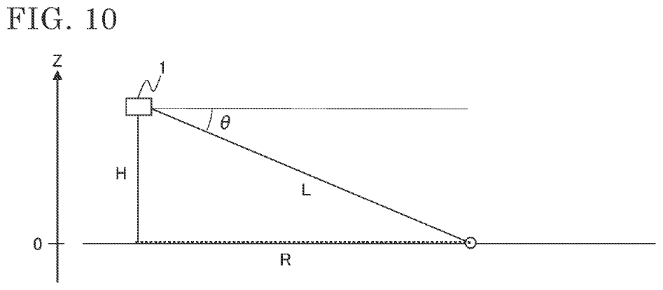

Specifically, as shown in FIG. 10, in the case where the depression angle θₙ of the laser n is determined and the laser sensor 1 is mounted horizontally at a height H, a ranging value L at a height 0 is represented as L=H sin θₙ, and a distance Rₙ between the ranging point and an intersection of a perpendicular extending from the sensor position to a plane at a height 0 is represented as Rₙ=H/tan θₙ. It is noted that, in the case where the depression angle θₙ of the laser n is not constant in one ranging point sequence, an average angle obtained by averaging the depression angles for the ranging points in the ranging point sequence may be used.

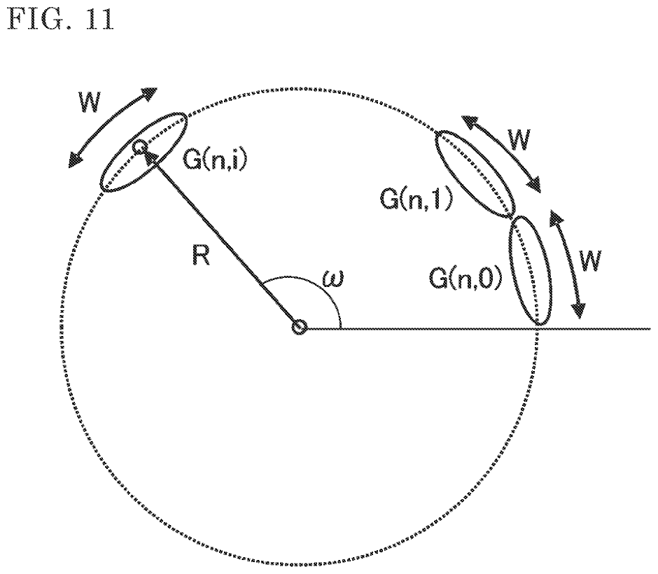

As shown in FIG. 11, an arc obtained by connecting the ranging points in the case where the laser n performs ranging for a plane at a height 0, is divided into areas per length W from θₙ=0 along the circumferential direction, thereby defining a road surface determination area G(n, i). Regarding the ranging point at the circumferential-direction angle ω for the laser n, the area into which the ranging point is classified is specified on the basis of Expression (8).

[Mathematical 8]

i=└ωRₙ/W┘ (8)

As described above, approximate road surface information in each direction around the laser sensor 1 is calculated. The upper limit for the number of areas may be set as a granularity for expressing a road surface, and with the height H set as H=1, the length W may be adjusted. Alternatively, the length W may be set in accordance with the desired size for determination in the actual road surface area, and information about the height at which the laser sensor 1 is mounted may be applied to the height H.

The laser sensor 1 applied here is a sensor that performs measurement over a range of 360° in the circumferential direction around the sensor, i.e., the entire direction range, as an example. Meanwhile, in the case where the measurement angle in the circumferential direction, i.e., the angle of view, is limited, the number of prepared areas varies in accordance with the angle of view, but the value of i can be calculated by Expression (8).

In the data dividing unit 301, the ranging results for the plurality of ranging points included in each road surface determination area G(n, i) are divided into groups on the basis of each shape determination result calculated in step ST103. That is, the ranging data is divided in each road surface determination area (FIG. 2, step ST104).

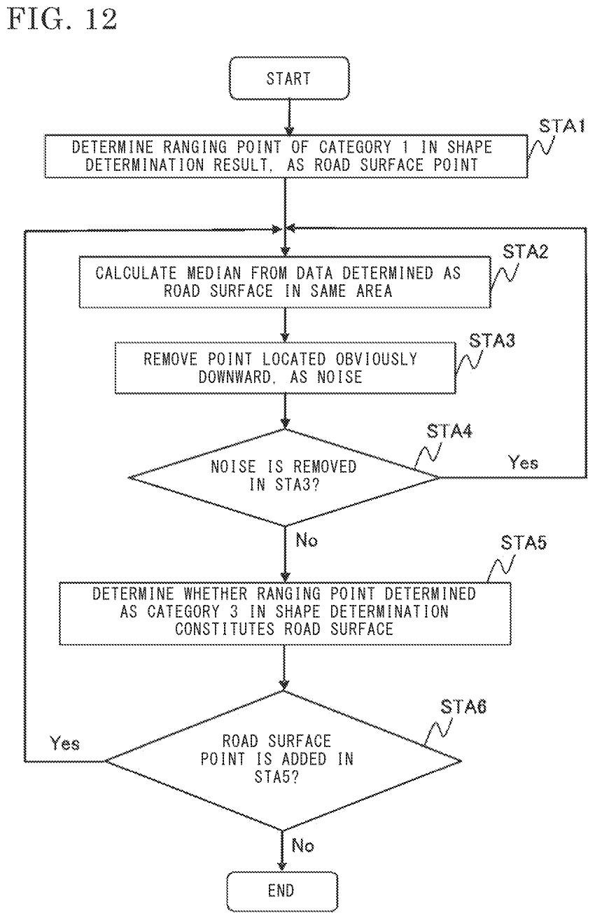

In the road surface point extraction unit 302, road surface information is generated on the basis of the shape determination results for the ranging points calculated in the above step ST103 (FIG. 2, step ST105). The detailed flow of this step will be described with reference to a flowchart shown in FIG. 12.

In each road surface determination area, the ranging point for which the shape determination result is category 1 is determined as a road surface point (FIG. 12, step STA1).

A median of the ranging values of the ranging points determined as a road surface in the road surface determination area G(n, i) is calculated and the median is defined as a representative ranging value mid_G(n, i) for this area (FIG. 12, step STA2). The value mid_G(n, i) is converted to a height in a sensor coordinate system, using depression angle information and the ranging value. Here, at the first time of the processing in step STA2, the shape determination result S(n, mₙ) for the laser of which the value of the depression angle is greatest in the perpendicular direction, i.e., the laser that is most downwardly directed, is 1, and hence the processing therefor is skipped.

Next, with a certain threshold set from the representative ranging value mid_G(n, i), if the ranging value of the ranging point determined as a road surface point in each road surface determination area is obviously present in the downward direction from the threshold, this value is removed as noise (FIG. 12, step STA3).

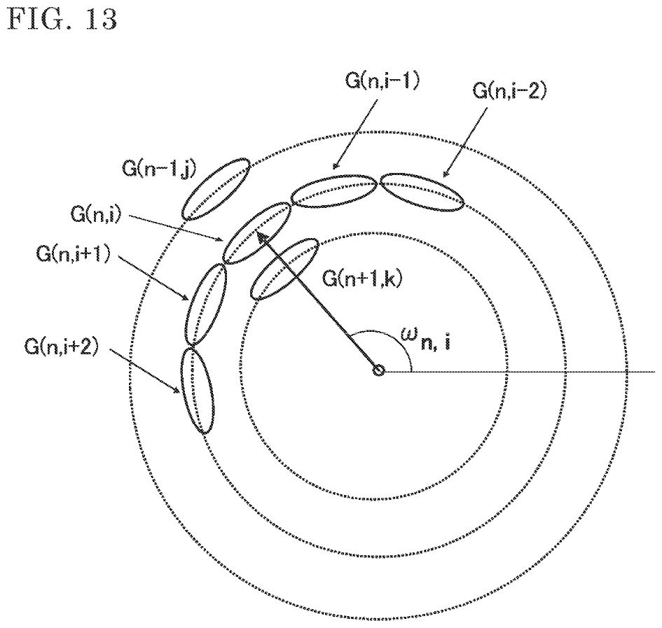

In this case, assumed noise is a ranging point present obviously downward of the road surface, like noise occurring due to multipath or the like. In addition, although the representative ranging value mid_G(n, i) for the attended road surface determination area may be used, in the case where the frequency of occurrence of noise is high, as shown in FIG. 13, representative ranging values for the adjacent road surface determination areas may be acquired and noise may be removed on the basis of the average value of the representative ranging values.

In FIG. 13, the case of acquiring representative ranging values from two areas at each of left and right in the circumferential direction of the road surface determination area that is a determination target, is shown as an example. However, the number of such areas may be three or more, in order to apply information from a wider range. Here, at the first time of the processing in step STA3, there is no representative ranging value mid_G(N, i) corresponding to the laser of which the ranging direction is at the greatest depression angle, i.e., the laser directed downward, and therefore noise is removed using the value of mid_G (N−1, j).

It is noted that j, k for defining the road surface determination areas G(n−1, j), G(n+1, k) for the laser n−1 and laser n+1 adjacent to G(n, j) can be calculated by the following Expressions (9), (10), using ω_{n,i} which is the circumferential-direction angle corresponding to the ranging point at the center of the road surface determination area G(n, j).

[Mathematical 9]

j=└ω_{n,i}Rₙ₋₁/W┘ (9)

[Mathematical 10]

k=└ω_{n,i}Rₙ₊₁/W┘ (10)

In step STA4, if there is a ranging point removed as noise in step STA3, step STA2 is performed again to update the median in each road surface determination area (FIG. 12, step STA4).

Next, regarding the ranging point determined as category 3 in the shape determination result, whether or not the ranging point is a ranging point constituting a road surface, i.e., a road surface point, is determined (FIG. 12, step STA5). Specifically, in each road surface determination area, if the ranging value determined as category 3 in the shape determination process is close to the representative ranging value, the ranging point is determined as a road surface point.

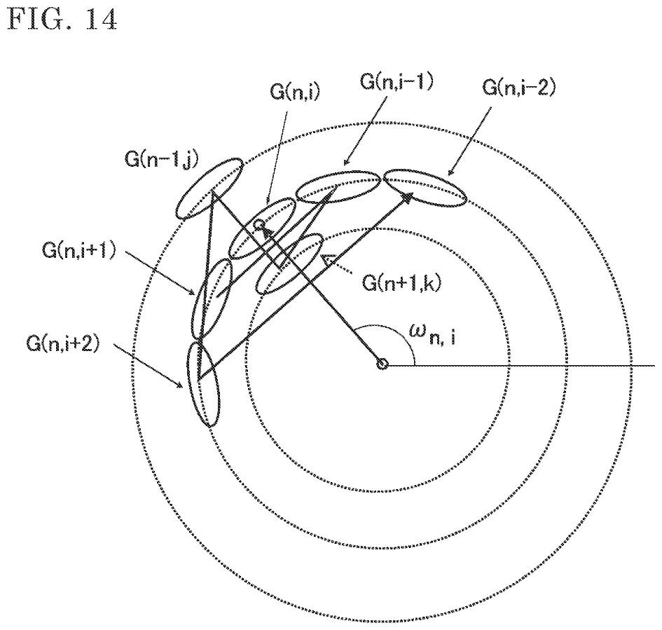

In the case of the area in which there is no representative ranging value mid_G, the road surface determination areas therearound are searched for the representative ranging value, to estimate the ranging value that is determined as a road surface in the corresponding road surface determination area. For example, as shown in FIG. 14, an area in which there is a representative ranging value mid_G is searched in the order from a closer road surface determination area.

In step STA5, if there is a ranging point to be added as a road surface point among the ranging points determined as category 3, step STA2 is performed again to update the median in each road surface determination area (FIG. 12, step STA6).

Through the above flow, the process for extracting road surface points from among the ranging points is finished.

From the road surface information calculated in the above step ST105, the road surface area calculation unit 303 generates road surface information for 1 frame, which is then stored into the memory 12 and outputted to the outside via the input/output interface 13 (FIG. 2, step ST106). It is noted that, in the step ST106 in FIG. 2, as an example of the road surface information, a representative value of the road surface points in each road surface determination area is outputted to the outside via the input/output interface 13.

Regarding an output content, in the case of extracting all of the road surface points and outputting them as point group information, or in the case of desiring to output as a smaller amount of information, it is possible to only output presence/absence of road surface information in each road surface determination area, the median of the road surface heights when road surface information is present, the number of road surface points, the ratio of road surface points when the number of all the ranging points included in the road surface determination area is used as a denominator, the number of ranging points determined as category 1 in the road surface shape determination, or the gravity center position. The height of the road surface can be calculated from the depression angle information and the ranging value of the ranging point, and the mounted position information of the laser sensor 1.

As described above, the road surface area detection device according to the first embodiment is configured such that, in the shape determination unit 200, the adjacent point specifying unit 202 is provided to be able to calculate the adjacency relationship for each ranging point received from the laser sensor 1, the angle calculation unit 203 calculates an angle formed by the adjacent ranging points with respect to each attended ranging point, i.e., each attention point, and the shape calculation unit 204 is provided to extract ranging points that are highly likely to constitute a road surface, and further classify the extracted ranging points into two groups, i.e., the ranging points that are highly likely to be road surface points, and candidate points that might be road surface points. Owing to this processing, the road surface point extraction unit 302 at the subsequent stage can easily extract road surface information around the laser sensor 1. That is, an effect that the road surface shape can be more accurately determined is provided.

In the road surface area extraction unit 300, the data dividing unit 301 defines road surface determination areas with the same size in the ranging point sequence for each laser of the laser sensor 1, and the shape determination result calculated by the shape calculation unit 204 is stored for each road surface determination area, whereby it becomes possible to calculate road surface information with the density of ranging points made constant with respect to the distance from the center of the laser sensor 1. The road surface point extraction unit 302 determines whether the ranging point constitutes a road surface, i.e., whether or not the ranging point is a road surface point, on the basis of the shape determination result by the shape determination unit 200. Thus, an area to be determined as a road surface can be expanded.

In addition, in the road surface area calculation unit 303, it is also possible to output all the group of points determined as a road surface, and in addition, in accordance with a request from the outside, road surface information with the density of ranging points made constant with respect to the distance from the center of the laser sensor 1 can be outputted, whereby the data transmission amount can be reduced.

### Second Embodiment

In the road surface area detection device according to the first embodiment, as the measurement configuration of the laser sensor 1, as shown in FIG. 4, the case of providing a plurality of lasers having different depression angles in the perpendicular direction, and rotating the lasers in the circumferential direction or performing a scan in a certain angle range in the circumferential direction, has been assumed. Therefore, as measurement points on the upward and downward sides to be used for performing determination on each measurement point by the shape determination unit 200, a result obtained by performing measurement with the lasers on the upward and downward sides at the same time can be used.

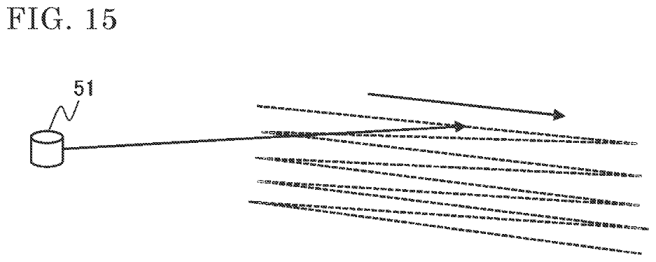

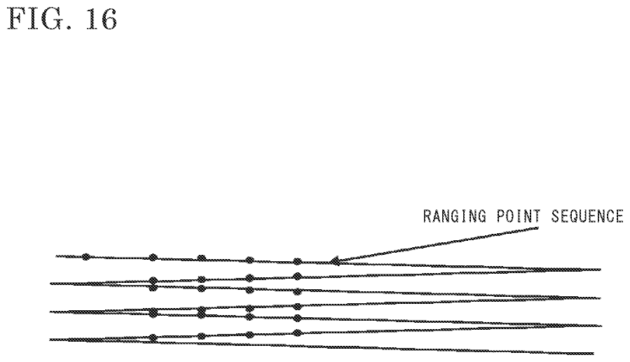

On the other hand, as shown in FIG. 15, there is also a laser sensor 51 which performs measurement by Raster-type scan while oscillating a single laser in the circumferential direction and controlling the depression angle thereof. If data acquired using such a laser sensor 51, i.e., data closest to the attended measurement result (the attention point) is selected as each adjacent point as in the first embodiment, there might be a problem that the intervals in the up-down direction between the ranging point sequences are not constant as shown in FIG. 16.

Accordingly, a road surface area detection device according to the second embodiment of the present disclosure aims at enabling application of the laser sensor 51 which performs measurement by Raster-type scan, by adding processing of selecting adjacent points to be extracted in calculation for the road surface shape.

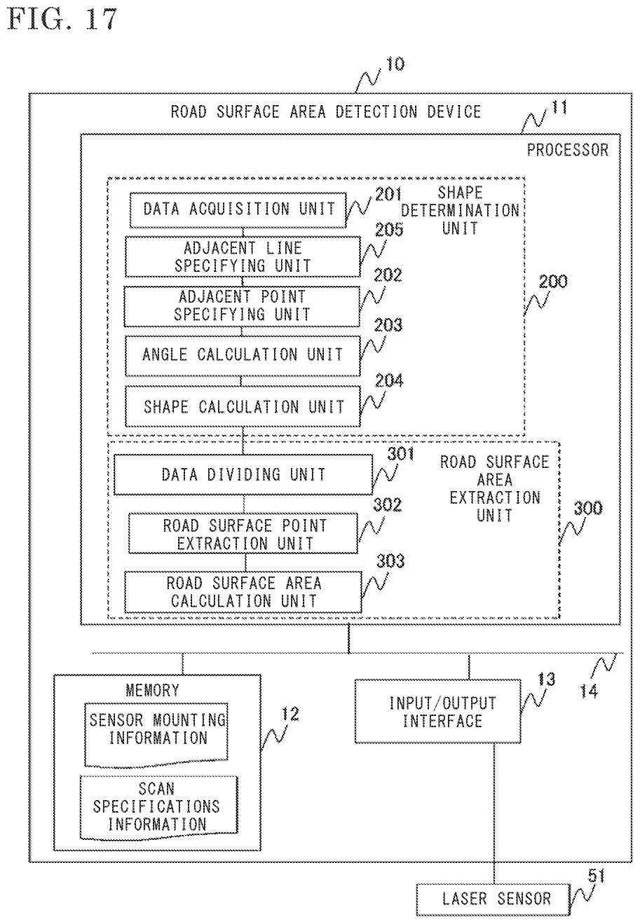

The road surface area detection device according to the second embodiment is configured such that, as shown in FIG. 17, an adjacent line specifying unit 205 is added to the configuration of the road surface area detection device according to the first embodiment.

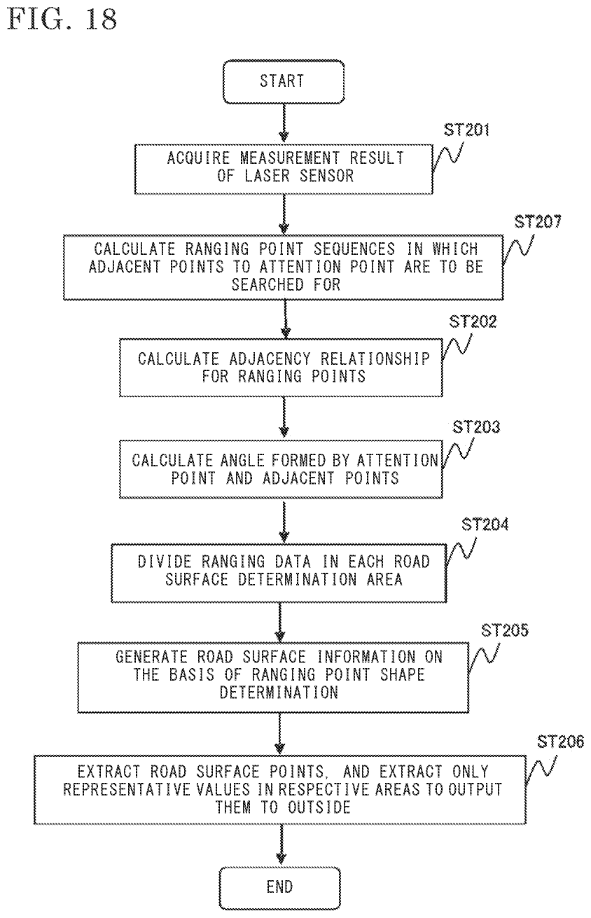

Next, operation of the road surface area detection device according to the second embodiment will be described with reference to a flowchart shown in FIG. 18.

Step ST201 is the same as in the first embodiment, and therefore the description thereof is omitted.

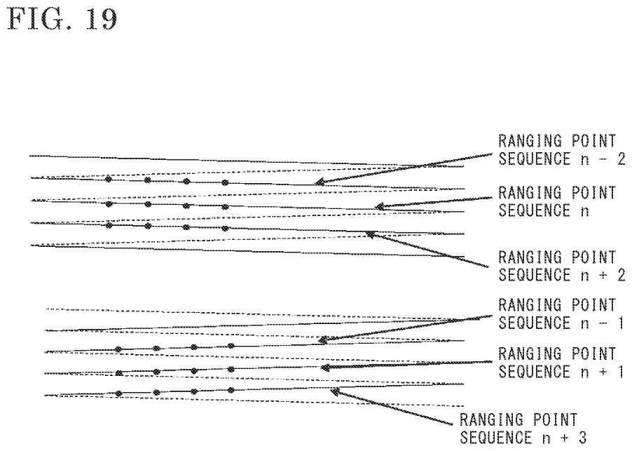

In step ST207, ranging point sequences in which adjacent points with respect to the attended ranging point, i.e., the attention point, are to be found, are specified. In the case of the laser sensor 51 which has a Raster-type scan direction, as shown in FIG. 19, ranging point sequences scanned in the same direction in the circumferential direction are extracted. For example, in the case of searching for adjacent points for the ranging point sequence n, two ranging point sequences of the ranging point sequence n−2 and the ranging point sequence n+2 which are ranging point sequences in the same direction in the circumferential direction, are selected.

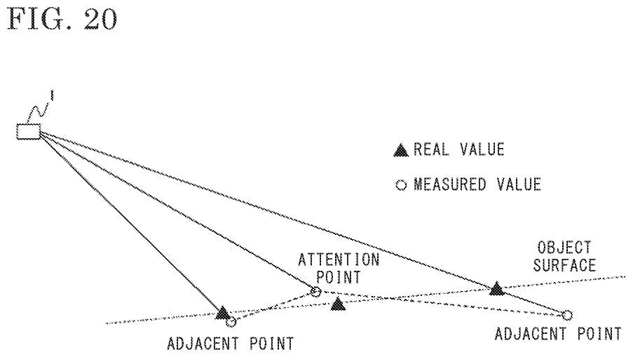

In addition, even in the case of the laser sensor 1 of the same type as in the first embodiment, when angular resolution per ranging point is small relative to the ranging accuracy of the laser sensor 1, the circumferential-direction angle might deviate from 180°, even for the ranging points obtained by measuring a flat surface. Specifically, as shown in FIG. 20, if there is a great variation in the positions of the acquired ranging points, a problem can occur in which the measurement result indicates a state having slopes even when a flat surface is actually measured. Further, in the case where numerical value variation is the same irrespective of the ranging distance, the magnitude of the influence on the shape determination result varies depending on the magnitudes of the ranging distance and the ranging direction difference. Considering this, ranging point sequences of which the ranging directions are sufficiently different from the attended ranging point, i.e., the attention point, are selected on the basis of the ranging accuracy and the ranging angle from the ranging specifications information.

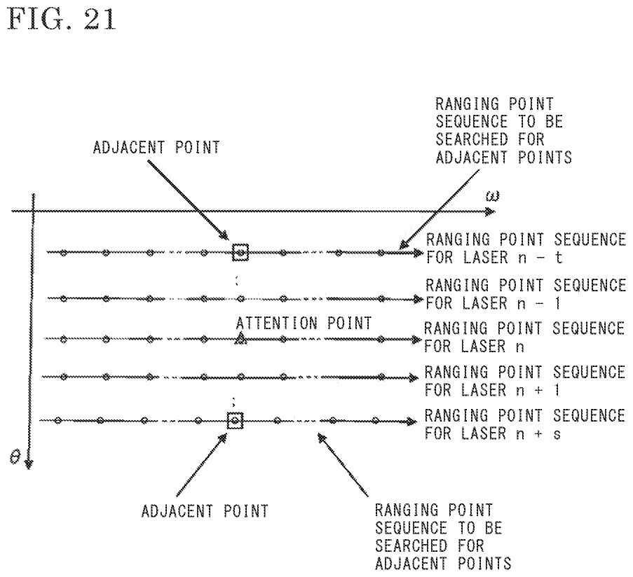

Specifically, as shown in FIG. 21, closest ranging point sequences s and t on the upward and downward sides are each specified such that the value of Expression (11) calculated on the basis of the ranging distance L and the depression angle difference for the attention point of the laser n is greater than a threshold (threshold2) according to the ranging accuracy of the laser sensor 1.

[Mathematical 11]

L*|ωₙ−ωₙ₊ₛ|>threshold2 (1<s<N−n)

L*|ωₙ−ωₙ₋ₜ|>threshold2 (1<s<n−1) (11)

It is noted that, also in the case of the laser sensor 51 which has a Raster-type scan direction, if the ranging accuracy and the scan interval are not well-balanced, ranging point sequences in sufficiently different ranging directions are selected using the ranging point sequences scanned in the same direction, as in the case of the laser sensor 1.

Steps ST202 to ST206 are the same as in the first embodiment, and therefore the description thereof is omitted.

As described above, in the road surface area detection device according to the second embodiment, the adjacent line specifying unit 205 is provided, whereby it is possible to suppress increase/decrease in the difference of the depression angle of the adjacent point with respect to the circumferential direction, even when the scan direction of the laser sensor 51 is a Raster type. In addition, in the case where the difference of the depression angle is small relative to the ranging accuracy of the laser sensor 51, by calculating a ranging point sequence in which the attention point is to be extracted, it is possible to reduce the influence of the ranging accuracy on the calculation result of the shape calculation unit 204 at the subsequent stage.

### Third Embodiment

In the road surface area detection devices according to the first and second embodiments, ranging points constituting a road surface, i.e., road surface points are extracted from the ranging points acquired from the laser sensor 1, to calculate road surface information around the laser sensor 1. In a road surface area detection device according to the third embodiment of the present disclosure, ranging points constituting a target object are further extracted on the basis of the calculated road surface information. In addition, on the basis of the extracted ranging points and information about the vehicle provided with the sensor, a road surface area on which the vehicle provided with the laser sensor 1 can travel is extracted from the road surface information.

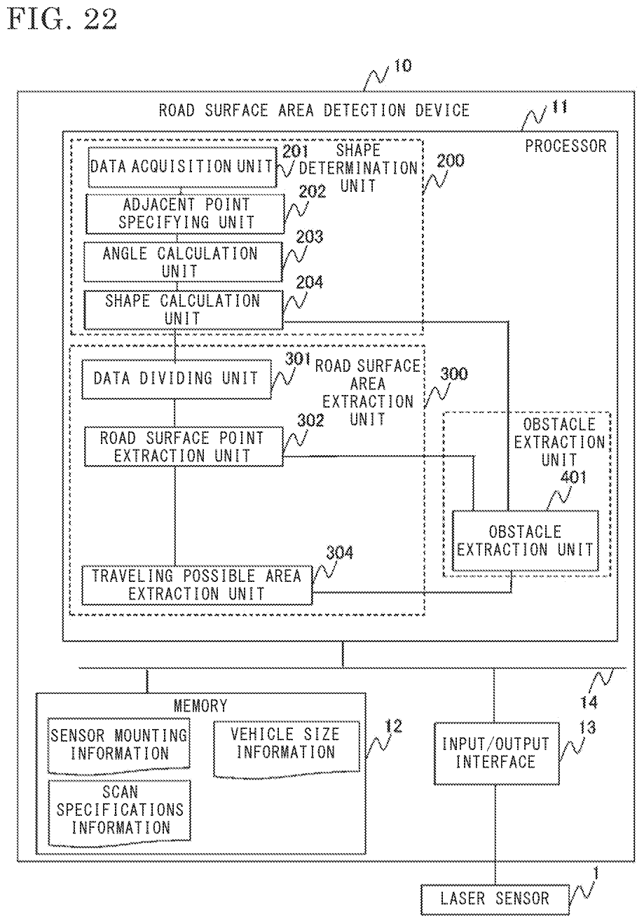

The road surface area detection device according to the third embodiment is configured such that, as shown in FIG. 22, an obstacle extraction unit 401 and a traveling possible area extraction unit 304 are added to the road surface area detection device according to the first embodiment.

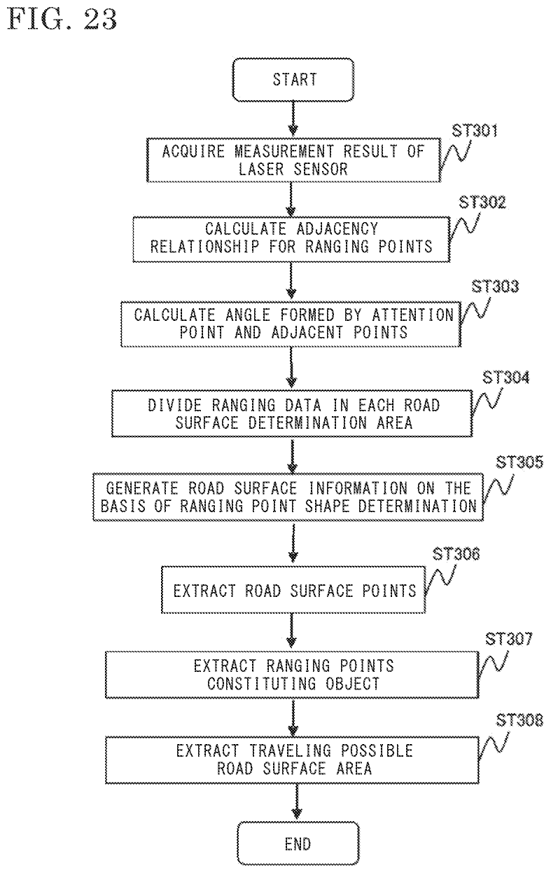

Next, operation of the road surface area detection device according to the third embodiment will be described with reference to a flowchart shown in FIG. 23.

Operation from step ST301 to step ST306 is the same as operation from step ST101 to step ST106 in the flowchart in FIG. 2 showing operation in the first embodiment, and therefore the description thereof is omitted.

In step ST307, from the ranging points that are not determined as ranging points constituting a road surface among all the ranging points, the obstacle extraction unit 401 extracts a ranging point at a certain height or more from the road surface height in the road surface determination area corresponding to each ranging point, as a ranging point constituting the target object. In the case where there is no point group constituting a road surface in the corresponding road surface determination area, the road surface height of a road surface determination area therearound is used for reference.

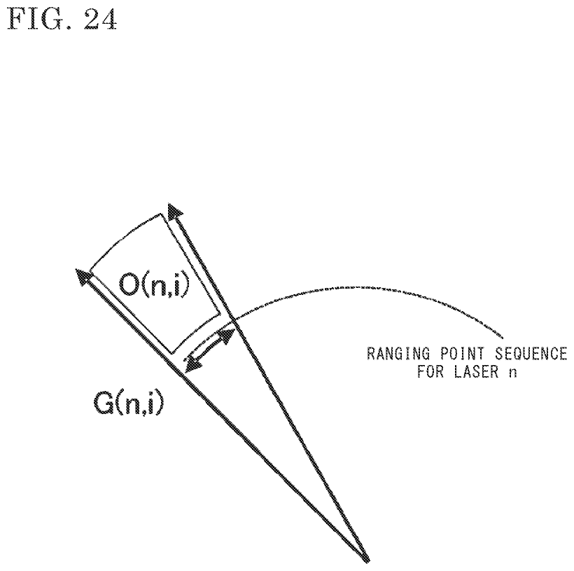

Here, whether or not the extracted ranging point constituting the target object is included in an object presence determination area O(n, i) is determined, and the ranging point information is registered for the corresponding area. As shown in FIG. 24, the object presence determination area O(n, i) is defined as an area which is in the circumferential-direction range covered by the road surface determination area G(n, i) having ranging points constituting a road surface, and which is rearward of ranging points included in G(n, i).

The object presence determination area O(n, i) as a target is determined as follows. Where the distance from the laser sensor 1 to the target ranging point is denoted by R and the distance from the laser sensor 1 calculated from the median of ranging values determined as a road surface in the road surface determination area in the same direction for each laser X is denoted by R_{X}, the maximum value of n that satisfies the following Expression (12) is calculated.

[Mathematical 12]

Rₙ<R<Rₙ₊ₘ(1<m,1<n<N) (12)

In step ST308, the traveling possible area extraction unit 304 extracts a traveling possible area on the basis of the road surface points extracted in the preceding step ST306, and the ranging points calculated in step ST307 and constituting an object.

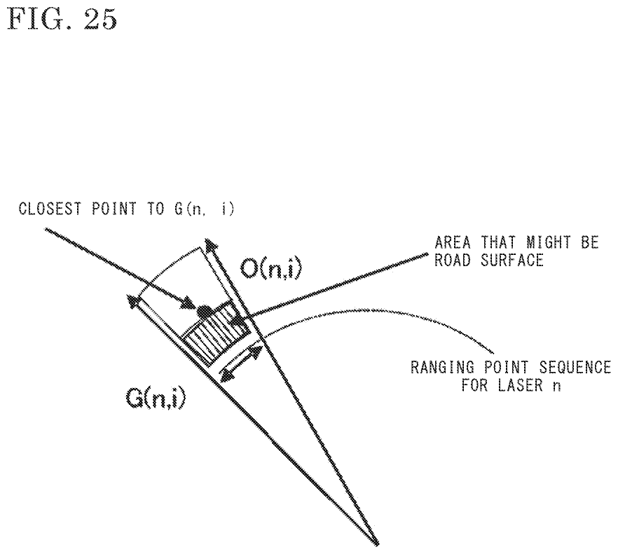

In the case where ranging point information is not stored in O(n, i) and there are a large number of road surface points in G(n, i) and G(n−1, j) adjacent to O(n, i), such an area is highly likely to be a road surface (case a). On the other hand, in the case where ranging points registered in two object presence determination areas on both sides across G(n, i) are at positions sufficiently close to G(n, i), and the heights of these ranging points are such heights that the vehicle will contact therewith when passing according to the vehicle size information, G(n, i) is determined such that the vehicle cannot pass therethrough (case b). A threshold for distance is set on the basis of, for example, the minimum size of an object to be detected in the operation environment. In addition, as shown in FIG. 25, in the object presence determination area in which the ranging points are registered, an area from the road surface point in G(n, i) to the position of the closest ranging point might be a road surface (case c).

In step ST308, finally, the ranging points determined as a road surface excluding those corresponding to the case b, and area information corresponding to the case a, are outputted. In addition, also the area defined in case c may be outputted as a traveling possible area having low reliability. Further, only such an area that the case b is not included in object presence determination areas present on a straight line from the center of the laser sensor 1 to O(n, i), may be outputted.

As described above, in the road surface area detection device according to the third embodiment, the obstacle extraction unit 401 is provided, whereby ranging points excluding road surface points and determined to be other than a road surface can be extracted from ranging points acquired from the laser sensor 1. Further, the traveling possible area extraction unit 304 is provided, whereby a road surface area on which the vehicle provided with the laser sensor 1 can travel, i.e., a traveling possible area, can be obtained.

### Fourth Embodiment

In the first and second embodiments, road surface points are extracted from ranging points acquired from the laser sensor 1, and road surface information around the laser sensor 1 is calculated. In a road surface area detection device according to the fourth embodiment of the present disclosure, an area of a lane on which a vehicle is traveling is extracted on the basis of the value of the reflection intensity of the extracted ranging point.

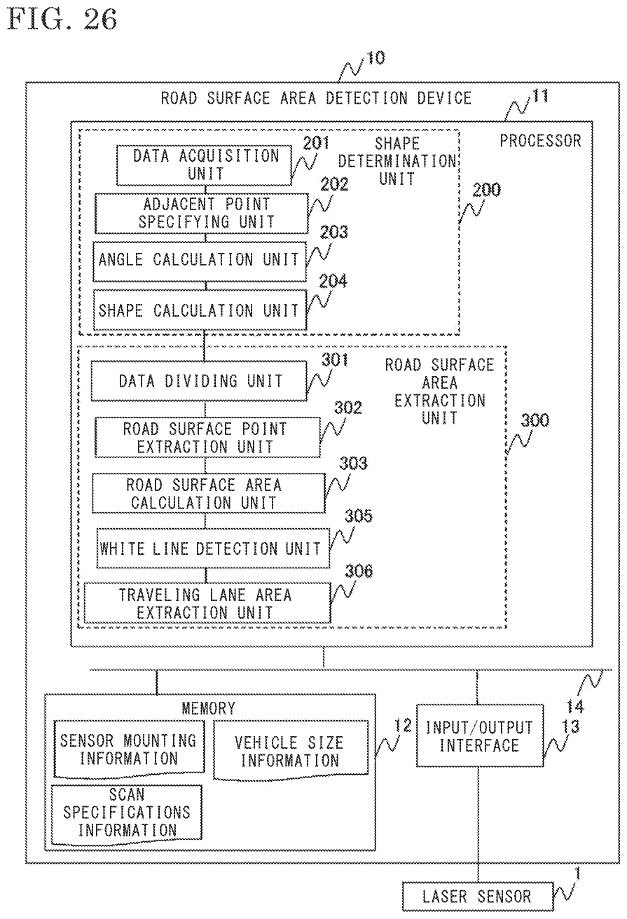

The road surface area detection device according to the fourth embodiment is configured such that, as shown in FIG. 26, a white line detection unit 305 and a traveling lane area extraction unit 306 are added to the configuration of the road surface area detection device according to the first embodiment.

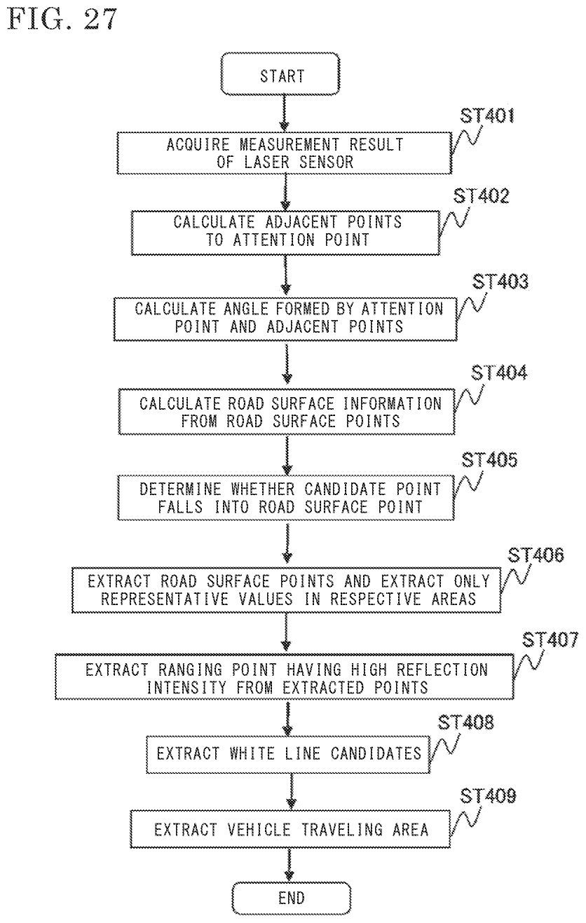

Next, operation of the road surface area detection device according to the fourth embodiment will be described with reference to FIG. 27.

Operation from step ST401 to step ST406 is the same as operation from step ST101 to step ST106 in the flowchart in FIG. 2 showing operation of the road surface area detection device according to the first embodiment, and therefore the description thereof is omitted.

In step ST407, a ranging point exhibiting a high reflection intensity is extracted from a road surface point group which is the ranging point group determined as ranging points constituting a road surface, i.e., road surface points in the preceding step. Here, a high reflection intensity means a reflection intensity not less than a threshold for reflection intensity, set in advance. In the case where ranging points exhibiting high reflection intensities are consecutively arranged, the closest point in the traveling direction may be used as a representative point, or the point located at the center of the consecutive ranging points may be used as a representative point.

In step ST408, the white line detection unit 305 obtains a candidate for a white line by connecting the road surface points extracted in the preceding step and exhibiting high reflection intensities. As an example of the method for obtaining the white line, the following method is conceivable, but the method is not limited thereto.

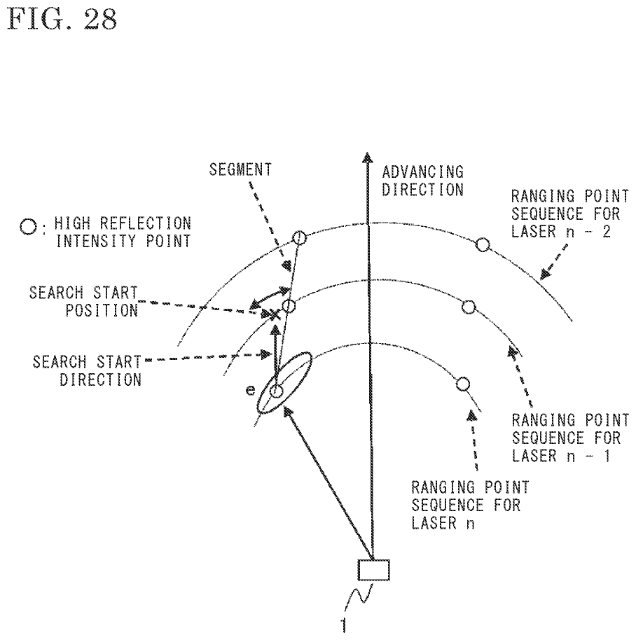

First, the advancing direction of the vehicle is acquired from the mounting position information of the laser sensor 1, and the acquired direction is used as a search reference direction. As shown in FIG. 28, in the ranging point sequence of the laser n−1 adjacent to the laser n, the ranging point present in the search reference direction from a ranging point e of the laser n is used as a start point and searching is performed therefrom in the left-right direction. Then, among the ranging points extracted in the preceding step ST407, the ranging point of which the angle difference from the search reference direction is small is selected to make a segment. The above processing is performed for all the ranging points extracted in the preceding step ST407, and a segment made sufficiently long through connection of such segments is determined as a white line.

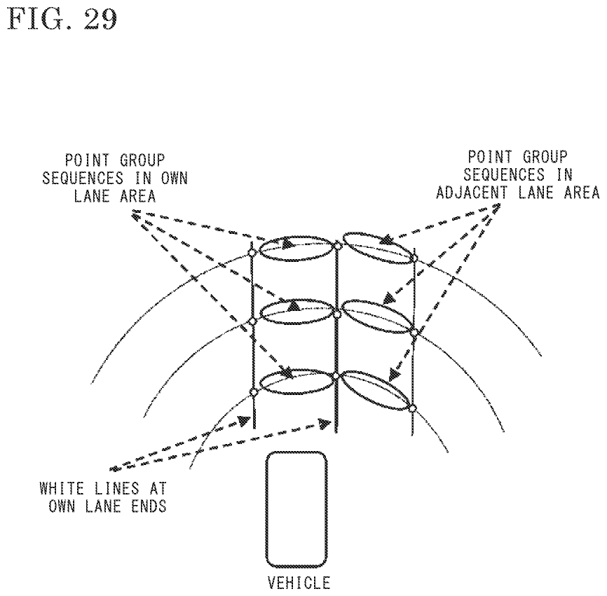

In step ST409, in the traveling lane area extraction unit 306, lines close to the left and right sides of the vehicle are extracted from the segments determined as white lines in the preceding step ST408 and the mounting position information and the vehicle size information of the laser sensor 1, and the extracted lines are used as white lines representing both ends of the own lane, as shown in FIG. 29. Then, the ranging points (i.e., road surface points) determined as a road surface present in the area between the two segments are outputted as a road surface point group constituting a road surface of an own lane area. It is noted that, as shown in FIG. 29, in the case where there is another white line outside the own lane, this white line may be determined as a white line of the adjacent lane area, and the ranging points included in the adjacent lane area may be outputted as ranging points constituting the adjacent lane.

As described above, in the road surface area detection device according to the fourth embodiment, the white line detection unit and the traveling lane area extraction unit are provided, whereby white lines can be detected from points extracted as road surface points on the basis of reflection intensity information, an area of the lane on which the vehicle is traveling can be extracted, and then, in the extracted area, an area measured as a road surface can be outputted. In addition, since the road surface determination areas are set and ranging point information is stored in a grouped manner, it is possible to efficiently perform searching in the left-right direction using a desired direction as a start direction.

In the above embodiments, the case of using the laser sensors 1, 51 as a sensor has been described as an example. However, the same effects can be obtained even by a sensor which emits another radiation signal, e.g., an ultrasonic sensor or a radio-wave laser.

In the above embodiments, the laser sensor 1 or the laser sensor 51 is a device separate from the road surface area detection device 10. However, the road surface area detection device and the laser sensor 1 or the laser sensor 51 may be combined as a set to form one road surface area detection system.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1, 51 laser sensor
10 road surface area detection device
11 processor
12 memory
13 input/output interface
14 signal line
200 shape determination unit
201 data acquisition unit
202 adjacent point specifying unit
203 angle calculation unit
204 shape calculation unit
205 adjacent line specifying unit
300 road surface area extraction unit
301 data dividing unit
302 road surface point extraction unit
303 road surface area calculation unit
304 traveling possible area extraction unit
305 white line detection unit
306 traveling lane area extraction unit
401 obstacle extraction unit

What is claimed is:

1. A road surface area detection device comprising at least one processor configured to implement:
a data accumulator which, with a sensor measuring ranging values representing distances to a target object by emitting a plurality of radiation signals different from each other in depression angles with respect to a perpendicular direction and measuring reflection signals obtained by the plurality of radiation signals being reflected from the target object, accumulates a ranging point sequence measured for each depression angle, the ranging point sequence being formed from the ranging values measured for a plurality of points along a circumferential direction around the perpendicular direction for each depression angle by the sensor;
an adjacent point specifying processing circuitry which sets an attended ranging point in one of the ranging point sequences as an attention point, and from a pair of ranging point sequences respectively located on a large depression angle side and a small depression angle side with respect to the depression angle for the one ranging point sequence, extracts the ranging points having circumferential-direction angles closest to a circumferential-direction angle of the attention point, as a pair of adjacent points;
an angle calculator which calculates an angle formed by the pair of adjacent points with respect to the attention point, as a difference angle; and
a shape calculator which, on the basis of a shape determination result determined from a shape represented by the attention point and the pair of adjacent points using the difference angle, classifies the attention point into any of a road surface point constituting a road surface, a candidate point for the road surface point, and a ranging point not constituting a road surface among the ranging points, and calculates a road surface shape on the basis of the classification.

2. The road surface area detection device according to claim 1, further comprising:
a data dividing processing circuitry which sets road surface determination areas through division into scan areas in which the ranging points are equally included with respect to a distance from a center of the sensor on the basis of the depression angles, and divides a plurality of the ranging points included in each road surface determination area, as a group, for each shape determination result;
a road surface point extractor which, on the basis of ranging point information calculated by the shape calculator and determined as the road surface, calculates an average value of the ranging values obtained in a case of performing ranging of the road surface in each road surface determination area, and determines whether or not the candidate point is the road surface point; and
a road surface area calculator which calculates, as output information, the road surface point extracted by the road surface point extractor.

3. The road surface area detection device according to claim 2, wherein
the road surface area calculator outputs 3-dimensional information about the road surface point.

4. The road surface area detection device according to claim 2, wherein
the road surface area calculator outputs, for each road surface determination area, one or more of presence/absence of the road surface point, a representative value of a road surface height when the road surface point is present, a number of the road surface points, a ratio of the road surface points with respect to all the ranging points included in the road surface determination area, a number of the road surface points, and a gravity center position.

5. The road surface area detection device according to claim 2, further comprising an adjacent line specifying processing circuitry for specifying the ranging point sequences that include the adjacent points to be used for calculation of the road surface shape.

6. The road surface area detection device according to claim 5, wherein
the adjacent line specifying processing circuitry specifies the ranging point sequences in which the adjacent points to be used for calculation of the road surface shape are to be searched for, on the basis of a direction in which the sensor scans.

7. The road surface area detection device according to claim 5, wherein
the adjacent line specifying processing circuitry specifies the ranging point sequences in which the adjacent points to be used for calculation of the road surface shape are to be searched for, on the basis of a measured distance for the attention point and depression angle information for each ranging point sequence.

8. The road surface area detection device according to claim 2, further comprising:
an obstacle extractor which, using the road surface points, extracts a ranging point constituting an object from the road surface points; and
a traveling possible area extractor which performs sorting of the road surface points and the ranging point extracted by the obstacle extractor and constituting the object, into an object presence determination area accompanying the road surface determination area set by the data dividing processing circuitry, and determines whether or not there is an object acting as an obstacle when a vehicle travels on the road surface.

9. The road surface area detection device according to claim 8, wherein
the traveling possible area extractor further has a function of determining whether or not there is an object in an area between the road surface determination areas, and outputting information about an area on which traveling of a vehicle provided with the sensor is possible.

10. The road surface area detection device according to claim 8, wherein
the traveling possible area extractor outputs 3-dimensional information about the ranging point constituting the road surface on which traveling is determined to be possible.

11. The road surface area detection device according to claim 9, wherein
the traveling possible area extractor outputs information about an area, between the road surface determination areas including the road surface points, where no ranging point is included in the object presence determination area.

12. The road surface area detection device according to claim 2, further comprising:
a white line detector which extracts, from the road surface points, road surface points having reflection intensities not less than a threshold, and generates segments connecting road surface points adjacent to each other among the extracted road surface points, to detect white lines; and
a traveling lane area extractor which extracts a traveling lane area by extracting the road surface points in an area between the white lines.

13. The road surface area detection device according to claim 1, wherein
the sensor is a laser sensor.

14. The road surface area detection device according to claim 13, wherein
the laser sensor includes a plurality of lasers.

15. The road surface area detection device according to claim 13, wherein
the laser sensor has a Raster-type scan direction.

16. A road surface area detection system comprising:
a sensor;
a road surface area detection device comprising at least one processor configured to implement;
a data accumulator which, with a sensor measuring ranging values representing distances to a target object by emitting a plurality of radiation signals different from each other in depression angles with respect to a perpendicular direction and measuring reflection signals obtained by the plurality of radiation signals being reflected from the target object, accumulates a ranging point sequence measured for each depression angle, the ranging point sequence being formed from the ranging values measured for a plurality of points along a circumferential direction around the perpendicular direction for each depression angle by the sensor;
an adjacent point specifying processing circuitry which sets an attended ranging point in one of the ranging point sequences as an attention point, and from a pair of ranging point sequences respectively located on a large depression angle side and a small depression angle side with respect to the depression angle for the one ranging point sequence, extracts the ranging points having circumferential-direction angles closest to a circumferential-direction angle of the attention point, as a pair of adjacent points;
an angle calculator which calculates an angle formed by the pair of adjacent points with respect to the attention point, as a difference angle;
a shape calculator which, on the basis of a shape determination result determined from a shape represented by the attention point and the pair of adjacent points using the difference angle, classifies the attention point into any of a road surface point constituting a road surface, a candidate point for the road surface point, and a ranging point not constituting a road surface among the ranging points, and calculates a road surface shape on the basis of the classification;
a data dividing processing circuitry which sets road surface determination areas through division into scan areas in which the ranging points are equally included with respect to a distance from a center of the sensor on the basis of the depression angles, and divides a plurality of the ranging points included in each road surface determination area, as a group, for each shape determination result;
a road surface point extractor which, on the basis of ranging point information calculated by the shape calculator and determined as the road surface, calculates an average value of the ranging values obtained in a case of performing ranging of the road surface in each road surface determination area, and determines whether or not the candidate point is the road surface point; and
a road surface area calculator which calculates, as output information, the road surface point extracted by the road surface point extractor.

17. A vehicle comprising:
a vehicle body;
a sensor provided on the vehicle body;
a road surface area detection device mounted inside the vehicle body comprising at least one processor configured to implement;
a data accumulator which, with a sensor measuring ranging values representing distances to a target object by emitting a plurality of radiation signals different from each other in depression angles with respect to a perpendicular direction and measuring reflection signals obtained by the plurality of radiation signals being reflected from the target object, accumulates a ranging point sequence measured for each depression angle, the ranging point sequence being formed from the ranging values measured for a plurality of points along a circumferential direction around the perpendicular direction for each depression angle by the sensor;
an adjacent point specifying processing circuitry which sets an attended ranging point in one of the ranging point sequences as an attention point, and from a pair of ranging point sequences respectively located on a large depression angle side and a small depression angle side with respect to the depression angle for the one ranging point sequence, extracts the ranging points having circumferential-direction angles closest to a circumferential-direction angle of the attention point, as a pair of adjacent points;
an angle calculator which calculates an angle formed by the pair of adjacent points with respect to the attention point, as a difference angle;
a shape calculator which, on the basis of a shape determination result determined from a shape represented by the attention point and the pair of adjacent points using the difference angle, classifies the attention point into any of a road surface point constituting a road surface, a candidate point for the road surface point, and a ranging point not constituting a road surface among the ranging points, and calculates a road surface shape on the basis of the classification;
a data dividing processing circuitry which sets road surface determination areas through division into scan areas in which the ranging points are equally included with respect to a distance from a center of the sensor on the basis of the depression angles, and divides a plurality of the ranging points included in each road surface determination area, as a group, for each shape determination result;
a road surface point extractor which, on the basis of ranging point information calculated by the shape calculator and determined as the road surface, calculates an average value of the ranging values obtained in a case of performing ranging of the road surface in each road surface determination area, and determines whether or not the candidate point is the road surface point; and
a road surface area calculator which calculates, as output information, the road surface point extracted by the road surface point extractor.

18. A road surface area detection method comprising:
accumulating a ranging point sequence measured for each depression angle with a sensor measuring ranging values representing distances to a target object by emitting a plurality of radiation signals different from each other in depression angles with respect to a perpendicular direction and measuring reflection signals obtained by the plurality of radiation signals being reflected from the target object, a ranging point sequence being formed from a ranging values measured for a plurality of points along a circumferential direction around the perpendicular direction for each depression angle by the sensor;
setting an attended ranging point in one of the ranging point sequences as an attention point, and from a pair of ranging point sequences respectively located on a large depression angle side and a small depression angle side with respect to the depression angle for the one ranging point sequence, extracting the ranging points having circumferential-direction angles closest to a circumferential-direction angle of the attention point, as a pair of adjacent points;
calculating an angle formed by the pair of adjacent points with respect to the attention point, as a difference angle;
classifying the attention point into any of a road surface point constituting a road surface, a candidate point for the road surface point, and a ranging point not constituting a road surface among the ranging points on the basis of a shape determination result determined from a shape represented by the attention point and the pair of adjacent points using the difference angle, and calculating a road surface shape on the basis of the classification;
setting road surface determination areas through division into scan areas in which the ranging points are equally included with respect to a distance from a center of the sensor on the basis of the depression angles, and dividing a plurality of the ranging points included in each road surface determination area, as a group, for each shape determination result;
calculating an average value of the ranging values obtained in a case of performing ranging of the road surface in each road surface determination area on the basis of ranging point information calculated in the shape calculating and determined as the road surface, and determining whether or not the candidate point is the road surface point; and
converting the road surface point extracted in the road surface point extracting, into output information, and outputting the output information.
